(19) United States
(12) Patent Application Publication
(10) Pub. No.: US 2014/0047691 A1
(43) Pub. Date: Feb. 20, 2014

(54) ELASTIC CONVEX WALL ALIGNMENT SYSTEM AND METHOD FOR PRECISELY LOCATING COMPONENTS

(71) Applicant: GM GLOBAL TECHNOLOGY OPERATIONS LLC, Detroit, MI (US)

(72) Inventors: Joel Colombo, Howell, MI (US); Steven E. Morris, Fair Haven, MI (US); Michael D. Richardson, Troy, MI (US)

(21) Appl. No.: 13/945,089

(22) Filed: Jul. 18, 2013

Related U.S. Application Data
(60) Provisional application No. 61/683,640, filed on Aug. 15, 2012.

(51) Int. Cl. B25B 11/02

(52) U.S. Cl. CPC B25B 11/02
USPC 29/407.09; 269/47

(57) ABSTRACT

An elastic convex wall alignment system for aligning components includes a first component and a second component. The system also has a plurality of upstanding elastic convex walls disposed on at least one of the components, the convex walls each having a convex wall surface and a non-convex wall surface. The system further has a plurality of apertures formed in at least one of the components, each aperture having an aperture wall, the plurality of apertures geometrically distributed in coordinated relationship to a geometrical distribution of the plurality of elastic convex walls such that each elastic convex wall is receivable into a respective aperture, wherein when each elastic convex wall is received into its respective aperture an elastic deformation occurs at an interface between the convex wall and the aperture wall, and wherein the elastic deformation is elastically averaged over the plurality of elastic convex walls.

### CROSS-REFERENCE TO RELATED APPLICATIONS

This patent application claims priority to U.S. Provisional Patent Application Ser. No. 61/683,640 filed Aug. 15, 2012, which is incorporated herein by reference in its entirety.

### FIELD OF THE INVENTION

The invention relates to location features and a system for aligning components having a relatively small size or contact area during a mating operation. More particularly, the invention relates to a plurality of mutually spaced apart elastic arcuate hollow wall alignment features of a first component which elastically deform on average when mated to receiving aperture alignment features of a second component to thereby precisely align the first and second components during a mating operation.

### BACKGROUND

The problem of positional variation exists in the mating of components that have a relatively small size or contact area over which the parts are mated. In mating such components, there is often not enough space to provide upstanding bosses and corresponding female alignment features, such as apertures in the form of holes or slots, in the mating component. In such situations, positional location and attachment are often combined by attachment using adhesives, including double-sided adhesive tape, where the components are visually and manually aligned to one another and then pressed into adhesive contact. The assembly of such components often results in undesirable non-uniform gaps and spacings between the components, including the presence of undesirably large assembly-to-assembly variations.

Therefore, an improved alignment system and method for components that have a relatively small size or contact area over which the parts are mated is very desirable.

### SUMMARY OF THE INVENTION

In one exemplary embodiment, an elastic convex wall alignment system for aligning components to one another is disclosed. The system includes a first component and a second component. The system also includes a plurality of upstanding elastic convex walls disposed on at least one of the first component and second component, the convex walls each having a convex wall surface and a non-convex wall surface. The system further includes a plurality of apertures formed in at least one of the first component and second component, each aperture having an aperture wall, the plurality of apertures geometrically distributed in coordinated relationship to a geometrical distribution of the plurality of elastic convex walls such that each elastic convex wall is receivable into a respective aperture, wherein when each elastic convex wall is received into its respective aperture an elastic deformation occurs at an interface between the convex wall and the aperture wall, wherein the elastic deformation is responsive to each convex wall having a maximum width larger than a cross-section of its respective aperture, and wherein the elastic deformation is elastic averaged over the plurality of elastic convex walls such that the first component is precisely located relative to the second component.

In another exemplary embodiment, a method for precisely aligning components of a motor vehicle during a mating operation is disclosed. The method includes providing a first vehicle component, the first vehicle component comprising a plurality of upstanding elastic convex walls connected to the first component, the convex walls each having a convex wall surface and a non-convex wall surface. The method also includes providing a second vehicle component having a plurality of apertures formed therein, each aperture having an aperture wall, the plurality of apertures of the second component geometrically distributed in a coordinated relationship to a geometrical distribution of the plurality of elastic convex walls such that each elastic convex wall is receivable into a respective aperture. The method further includes mating the first vehicle component to the second vehicle component, wherein during mating the first vehicle component is aligned to the second vehicle component by each said elastic convex wall being received into its respective aperture. Still further, the method includes elastically deforming an interface between each elastic convex wall and its respective aperture in the second vehicle component. Yet further, the method includes performing an elastic averaging of the elastic deformation over the plurality of elastic convex walls such that upon mating, a precise location of the first vehicle component to the second vehicle is realized.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic top plan view of an embodiment of an alignment system and assembly as disclosed herein;

FIG. 2 is a cross-sectional view of FIG. 1 taken along Section 2-2 illustrating an embodiment of an elastic convex wall as disclosed herein;

FIG. 3 is a cross-sectional view of another embodiment of an elastic convex wall as disclosed herein;

FIGS. 4A-4G are schematic top views of various embodiments of elastic convex walls as disclosed herein; and

FIG. 5 is a flowchart of a method of aligning an assembly of components as disclosed herein.

### DESCRIPTION OF THE EMBODIMENTS

The invention is an elastic convex wall alignment system for the precise mating of two components, particularly motor vehicle components, wherein when mating is completed there is a lack of float (or play) as between the male and female alignment features so as to provide a precision alignment with stiffened positional constraint, yet the aligned mating proceeds smoothly and effortlessly each time.

The following description is merely exemplary in nature and is not intended to limit the present disclosure, its application or uses. For example, the embodiments shown comprise vehicle emblems as may be used, for example, to identify a vehicle brand or make, or a vehicle model, or a model feature or characteristic (e.g., hybrid, AWD and the like), but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various other interior, exterior and under hood vehicular components and applications. The elastic convex wall alignment system is particularly useful for the precise mating alignment of two components where one or both of the components have fine spacings or narrow features, such as frames, channels, ribs or arms that define letters, logos, symbols, or trim, that will not accommodate the implementation of other alignment systems that include larger alignment features, such as full elastic averaging tubes or tabs. It should be understood that throughout the drawings, corresponding reference numerals indicate like or corresponding parts and features.

As used herein, the terms “elastic” or “elastically deformable” and the like refer to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

The elastic convex wall alignment system according to the invention operates on the principle of elastic averaging. A plurality of geometrically separated elastic convex wall (male) alignment features are disposed on a first component, while a plurality of one-to-one corresponding aperture (female) alignment features are provided on a second component, wherein the elastic convex wall alignment features have a maximum width exceeding a cross-section of the aperture alignment features. However, the first and second components may each have some of the elastic convex wall alignment features and some of the aperture alignment features so long as they correspond one-to-one so that they are mutually engageable with one another. During the mating of the first component to the second component, each elastic convex wall alignment feature respectively engages its corresponding aperture alignment feature. As the elastic convex wall alignment features are received into the aperture alignment features, any manufacturing variance in terms of position and size of the elastic convex wall and aperture alignment features is accommodated by elastic deformation, on average, at the interface between the elastic convex wall and aperture alignment features. This elastic averaging across the plurality of elastic convex wall and aperture alignment features provides a precise alignment as between the first and second components when they are mated relative to each other, and yet the mating proceeds smoothly and easily.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675 filed on Jul. 21, 2011 and Ser. Nos. 13/567,580 filed on Aug. 6, 2012, the disclosures of which are incorporated by reference herein in their entirety. The embodiments disclosed above provide the ability to convert an existing component that is not compatible with the above-described elastic averaging principles to an assembly that does facilitate elastic averaging and the benefits associated therewith.

According to the invention, the elastic convex wall alignment features are elastically deformable by elastic compression of the convex wall surface of the elastic convex wall, which deformation is preferably resiliently reversible. In an exemplary application of the invention, the elastic convex wall alignment features are connected (typically integrally) with a first component in upstanding, perpendicular relation to a predetermined surface of the first component. Further according to the invention, it is possible, but not required, for the respective aperture alignment members to be elastically deformable by elastic expansion of the aperture wall of the apertures, which deformation is preferably resiliently reversible. In an exemplary embodiment, the aperture alignment features are disposed in a second component, typically as a slot or a hole in predetermined surfaces of the second component, wherein the maximum width of the elastic convex wall alignment features exceeds the cross-sectional width of the aperture alignment features (i.e., an interference condition exists), whereby elastic deformation occurs as each elastic convex wall alignment feature is received into its respective aperture alignment feature. The process of mating with precise alignment is both smoothly and easily performed. This is enhanced by a tapering (smaller diameter with increasing height) of the elastic convex wall alignment features so as to facilitate their initial entry into the aperture alignment features, and by beveling of the aperture wall of the aperture alignment features so as to locally pronounce the elastic deformation at the interface of the aperture wall with the elastic convex wall.

In operation, as the first and second components are mated together, the initial contact therebetween is at the plurality of geometrically spaced apart elastic convex wall alignment members passing into their one-to-one corresponding aperture alignment features. Because of the larger size of the width of the elastic convex wall alignment features relative to the cross-section of the aperture alignment features, an elastic deformation occurs at the interface therebetween, and this deformation is averaged over the geometrical distribution of the plurality of elastic convex wall alignment features. The alignment becomes precise when all of the first and second components have fully mated because the tapering of the elastic convex wall alignment features provides a maximum width to the cross-section of the aperture alignment features when these components have arrived at final mating. When an affixment modality is implemented, such as for example threaded fasteners, heat staking, sonic welding, push nuts, clips, etc., the precise alignment becomes manifest, and the visible joint between the two components is a perfect Class A finish with predetermined gap and spacing requirements between the components having been established.

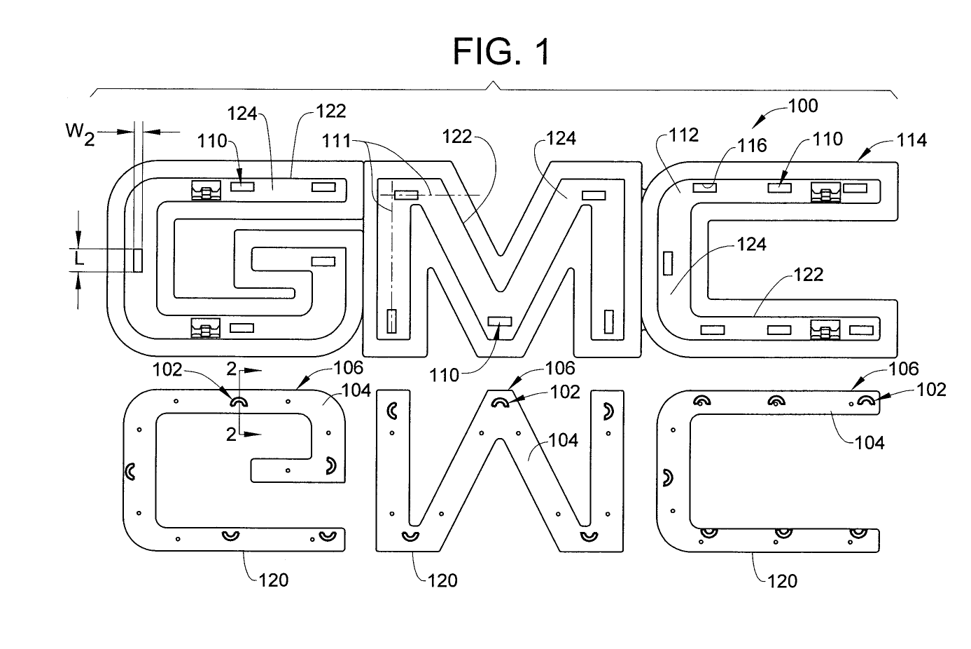

Referring now to the Figures, FIGS. 1-5 depict various examples of the structure and function of the elastic convex wall alignment system 100 disclosed herein.

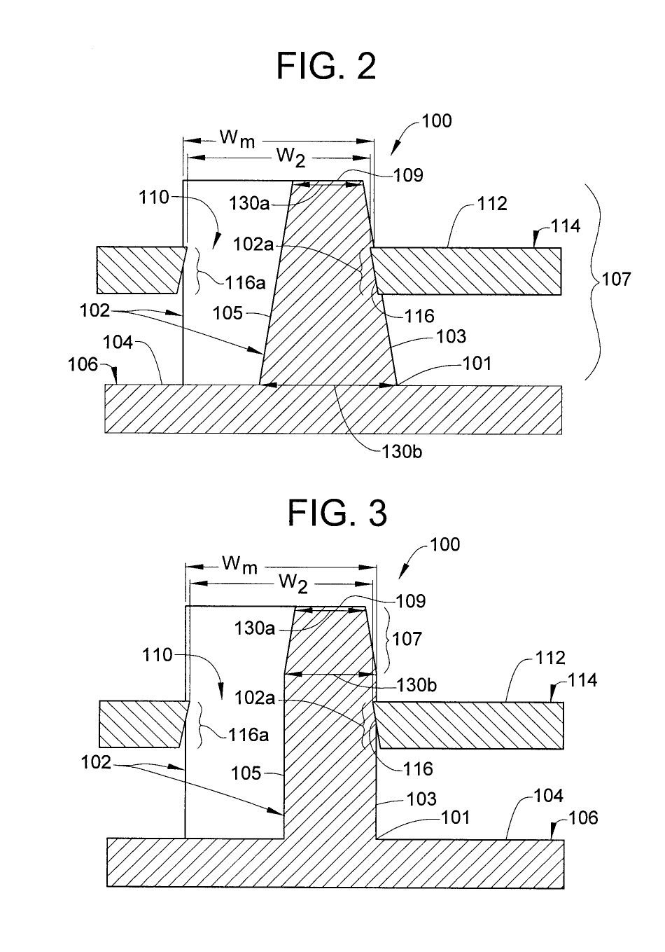

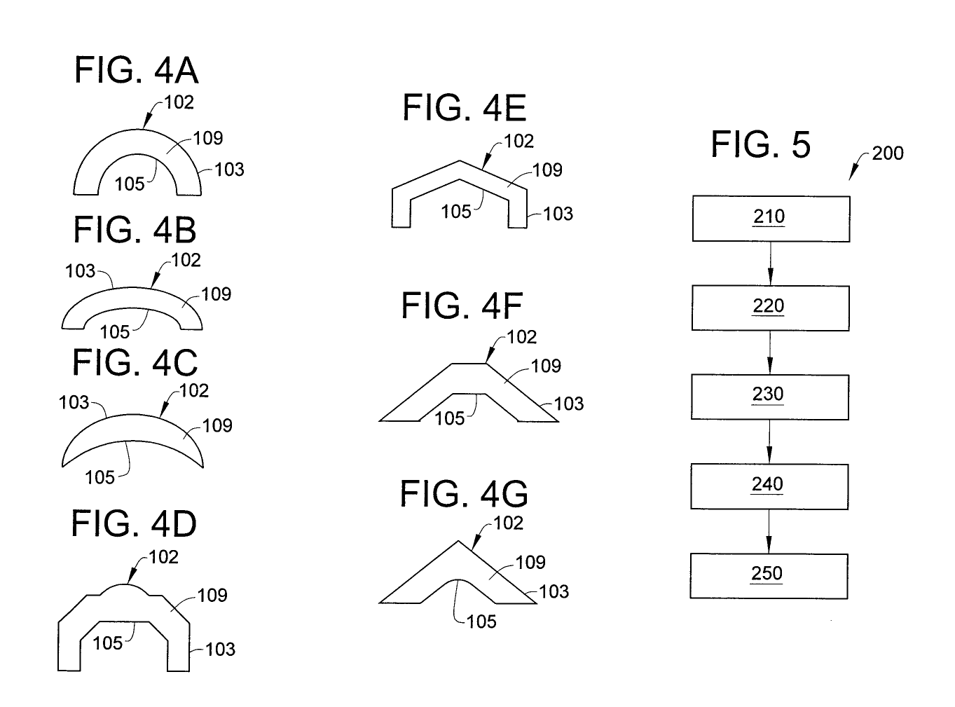

The elastic convex wall alignment system 100 operates on the principle of elastic averaging. A plurality of mutually separated elastic convex wall alignment features (serving as male alignment features) 102 (hereinafter referred to simply as “elastic convex walls”) are disposed on a first surface 104 of a first component 106, or a plurality of first components 106 (FIG. 1). As best shown in FIGS. 1-3, the elastic convex walls 102 are upstanding in a normal relation to the first surface 104, wherein 6 mutually separated elastic convex walls are on the surface of the first component 106. The elastic convex walls may be spaced apart in any suitable pattern, and will preferably be arranged in a pattern or geometrical distribution that provides a predetermined alignment of the first component 106 and a second component 114, such as a predetermined gap or spacing (e.g. a uniform gap or spacing) of the periphery 120 the first component 106 (or components) nested within a periphery 122 of a mating recess 124 of the second component 114. Each of the elastic convex walls 102 is convex in shape, having a convex wall surface 103. The convex wall surface 103 of the elastic convex wall 102 may have any suitable convex shape, including all manner of convex curved surface shapes (FIGS. 4A-4D) and convex polygonal surface shapes (FIGS. 4E-G). Suitable convex curved wall surface 103 shapes include any convex arcuate wall surface 103 shape, such as, for example, hemitubular or partially tubular (FIGS. 1-3 and 4A, elliptical shapes (FIG. 4B) and half-moon shapes (FIG. 4C), as well as substantially polygonal shapes having a convex arcuate wall surface 103. Suitable convex polygonal wall surface 103 shapes include any regular or irregular polygonal surface shapes having various acute angles therebetween, including various 4-sided shapes (FIG. 4E), three-sided shapes (FIG. 4F) and two-sided shapes (FIG. 4G). The elastic convex wall 102 also has an opposing wall surface 105. The opposing wall surface 105 may have any suitable shape that allows the elastic deformation of the convex wall surface 103, including various concave wall surfaces (FIGS. 4A-G). The convex wall surfaces 103 and opposing wall surfaces 105 may be combined in any manner, including any of the convex wall surfaces 103 illustrated with any of the opposing wall surfaces 105. These shapes are only exemplary illustrations of many curved and polygonal wall surfaces 103 and opposing wall surfaces 105 that may be employed. The elastic convex wall has a maximum width (Wₘ) as shown in FIGS. 2 and 3. The elastic convex wall 102 also may have a bevel 107 proximate a distal end 109 of the wall. The bevel 107 may extend along a portion of the wall (FIG. 3) or along the entire wall (FIG. 2). The elastic convex wall 102 is elastic, being preferably stiffly elastic, wherein the shape is resiliently reversible in response to an elastic compressive force being applied thereto sufficient to elastically deform the elastic convex walls 102.

A plurality of aperture alignment features (serving as female alignment features) 110 (hereinafter referred to simply as “apertures”) are disposed in a second surface 112 of a second component 114, being located in one-to-one correspondence with the plurality of elastic convex walls 102; that is, for each elastic convex wall is a respective aperture into which it is receivable. Thus, the plurality of apertures is geometrically distributed in coordinated relationship to a geometrical distribution of the plurality of elastic convex walls such that each elastic convex wall is receivable into its respective aperture. While the apertures 110 are shown as elongated slots, it is clear the aperture shape could be otherwise, such as for example an elongated hole, a generally round hole, etc. Preferably, an aperture wall 116 which defines the opening demarcation of the aperture alignment features 102 is beveled 116a. A preferred material for the second component 114 in which the apertures 110 are disposed is one having elastic properties so as to deform without fracture, as described herein.

As illustrated in FIG. 1, the apertures 110 may have any suitable shape, including an elongated shape having a length (L) greater than a width (W₂), such as a rectangle, rounded rectangle, or a rectangular shape having ends defined by outwardly extending, opposed curved (e.g. circular) arcs. In one embodiment, the elongated apertures may have a substantially uniform aperture width except in the end regions, which may be rounded or curved as described herein. The apertures of a given component may have the same size, or different sizes. The apertures 110 of the second component 114 have a second aperture width (W₂).

The elongated apertures 110 of the second component 114 have elongation axes 111, FIG. 2, along their length (i.e. the elongated dimension). For respective apertures 110, the apertures may be arranged so that the respective axes are parallel to one another or not parallel to one another. In one embodiment, a predetermined portion of the second elongation axes 111 are parallel. In another embodiment, a predetermined portion of the second elongation axes 111 are not parallel to the other second elongation axes 111, and may be orthogonal to these axes.

The first and second components 106, 114 may include motor vehicle components; however, this is not a requirement. The alignment system 100 may be employed with any suitable number of components, and is not limited to application with only two components. While the embodiments herein are described using two components, more than two components can be aligned using the alignment system 100 described herein, including a third, fourth, etc. component, in any number.

As depicted schematically in FIGS. 2 and 3, the maximum width Wₘ of the elastic convex walls 102 exceeds a width W₂ of the apertures 110, whereby elastic deformation proceeds as each elastic convex wall is received into its respective aperture. As in FIGS. 2 and 3, the elastic deformation of the tube wall 102a is locally pronounced due to the beveling 116a of the aperture wall 116, wherein there is provided a relatively small contact area as between the aperture wall contact surface 116a and the tube wall 102a. Since the compressive force between the aperture wall and the tube wall is limited to the smaller surface area of the aperture wall contact surface, a higher compressive pressure is provided.

The process of mating the first component 106 to the second component 114 is both smoothly and easily performed, facilitated by a tapering (smaller diameter with increasing height, as shown comparatively at FIG. 3 by distal and proximal diameters 130a and 130b of the distal 109 and proximal ends 101 of the elastic convex wall 102. In this regard, the tapering of the elastic convex walls presents a larger diameter 130b, which may be the largest diameter, at the cross-section of the apertures 110 when the first and second components have arrived at final mating; further, the tapering may present a smallest diameter 130a of the elastic convex wall 102 at the distal end 109 so as to ease initial entry of the elastic convex walls into the apertures.

During the mating of the first component 106 to the second component 114, each elastic convex wall 102 respectively engages its corresponding aperture 110 wherein as the elastic convex walls pass into the apertures, any manufacturing variance in terms of position and size thereof is accommodated by elastic deformation on average of the plurality of elastic convex walls and apertures. This elastic averaging across the plurality of elastic convex walls and apertures 102, 110 provides a precise alignment as between the first and second components 106, 114, and any additional components, when they are finally mated relative to each other.

Further according to the invention, it is possible, but not required, for the apertures 110 to be also elastically deformable by elastic expansion of the aperture sidewall, which deformation is also preferably reversible.

The operation of the elastic convex wall alignment system 100 is described below. The first and second components 106, 114 are brought into close proximity with near alignment. As the first and second components 106, 114 are mated together, the initial contact therebetween is via the plurality of geometrically spaced apart elastic convex walls 102 passing into their one-to-one corresponding apertures 110 where the first and second components align to one another. The alignment is precise in FIGS. 1-3, wherein the first and second components 106, 114 have now fully mated. The alignment is precise because the larger size (e.g. largest) diameter of elastic convex walls, 102 relative to the cross-section of the apertures 110, results in elastic deformation of the walls, and this elastic deformation is elastically averaged over the plurality of geometrically distributed elastic convex walls. When an affixment modality is implemented, such as for example threaded fasteners, heat staking (e.g., by locally melting and deforming the tops of the tubes), sonic welding, etc., the precise alignment becomes manifest, and if the components comprise surfaces visible to a user, the visible joint between the two components may include show surfaces having a Class A finish.

The elastic convex walls 102 and the apertures 110 may reside on either of the first or second components, respectively, and indeed, some elastic convex walls and some apertures may be present on each of these components. Additionally, while hemitubular elastic convex walls 102 are particularly useful, the shape may also include other curved and non-curved shapes in any combination, including having elastic convex walls of different shapes on first component 106 or second component 114, or both of them.

Several notable aspects and advantages of the invention may be understood from the foregoing description. The invention: 1) eliminates the manufacturing variation associated with the clearances needed for 2-way and 4-way locating schemes of the prior art; 2) reduces the manufacturing variation by elastically averaging the positional variation; 3) eliminates the float of components as is present in the prior art; 4) provides an over constrained condition that reduces the positional variation by averaging out each locating features variation, and additionally stiffens the joint reducing the number of needed fasteners; 5) provides more precise location of components; and, 6) provides a stiffened assembly of the mated first and second components with reduction or elimination of buzz, squeak and rattle (BSR) through elastic deformation with respect to each other, and thereby improves the noise, vibration and harshness (NVH) performance of the assembly of the components.

Any suitable elastically deformable material may be used for the first component 106 or second component 114, for example, particularly those materials that are elastically deformable when formed into the features described herein. This includes various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features and components described herein. The elastic convex walls 102 may be formed in any suitable manner. They may be integrally formed or manufactured with the first component 106 or they may formed together separately and attached to the first component, or they may both be formed entirely separately and attached to the first component. When formed separately, they may be formed from different materials than those of the first component 106 to provide a predetermined elastic response characteristic, for example. The material, or materials, may be selected to provide a predetermined elastic response characteristic of any or all of the first component 106 or second component 114. The predetermined elastic response characteristic may include, for example, a predetermined elastic modulus.

In an exemplary embodiment, a method 200 for precisely aligning components of a motor vehicle during a mating operation is disclosed. The method 200 includes providing 210 a first vehicle component 106, the first vehicle component comprising a plurality of upstanding elastic convex walls 102 connected to the first component, the convex walls each having a convex wall surface 103 and an opposing wall surface 105. The method 200 also includes providing 220 a second vehicle component 114 having a plurality of apertures 110 formed therein, each aperture having an aperture wall 116, the plurality of apertures of the second component geometrically distributed in a coordinated relationship to a geometrical distribution of the plurality of elastic convex walls such that each elastic convex wall is receivable into a respective aperture. The method further includes mating 230 the first vehicle component to the second vehicle component, wherein during mating the first vehicle component is aligned to the second vehicle component by each said elastic convex wall being received into its respective aperture. Still further, the method 200 includes elastically deforming 240 an interface between each elastic convex wall and its respective aperture in the second vehicle component. Yet further, the method 200 includes performing 250 an elastic averaging of the elastic deformation over the plurality of elastic convex walls such that upon mating, a precise location of the first vehicle component to the second vehicle is realized.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic convex wall alignment system for aligning components to one another, comprising:
a first component;
a second component;
a plurality of upstanding elastic convex walls disposed on at least one of the first component and second component, the convex walls each having a convex wall surface and a non-convex wall surface;
a plurality of apertures formed in at least one of the first component and second component, each aperture having an aperture wall, the plurality of apertures geometrically distributed in coordinated relationship to a geometrical distribution of the plurality of elastic convex walls such that each elastic convex wall is receivable into a respective aperture, wherein when each elastic convex wall is received into its respective aperture an elastic deformation occurs at an interface between the convex wall and the aperture wall, wherein the elastic deformation is responsive to each convex wall having a maximum width larger than a cross-section of its respective aperture, and wherein the elastic deformation is elastically averaged over the plurality of elastic convex walls such that the first component is precisely located relative to the second component.

2. The elastic convex wall alignment system of claim 1, wherein the elastic convex walls comprise elastic arcuate walls.

3. The elastic convex wall alignment system of claim 2, wherein the elastic arcuate walls each have a convex wall surface and a concave wall surface.

4. The elastic convex wall alignment system of claim 2, wherein the arcuate walls comprise hemitubular walls.

5. The elastic convex wall alignment system of claim 1, wherein the elastic convex walls comprise elastic non-cylindrical walls.

6. The elastic convex wall alignment system of claim 5, wherein the elastic non-cylindrical walls comprise convex polygonal surfaces as the convex surface.

7. The elastic convex wall alignment system of claim 6, wherein the elastic non-cylindrical walls comprise concave polygonal surfaces as the non-convex surface.

8. The elastic convex wall alignment system of claim 1, wherein the elastic deformation comprises resiliently reversible elastic deformation of each convex wall.

9. The elastic convex wall alignment system of claim 1, wherein resiliently reversible elastic deformation of each convex wall comprises deformation of the convex surface and the non-convex surface.

10. The elastic convex wall alignment system of claim 8, wherein said elastic deformation further comprises resiliently elastic deformation of each aperture wall.

11. The elastic convex wall alignment system of claim 8, wherein said elastic deformation provides a stiffened assembly of the first component and second component when these components are mutually mated to each other.

12. The elastic convex wall alignment system of claim 8, wherein a predetermined number of the elastic convex walls are heat staked after the first component and second component have been mated to one another.

13. The elastic convex wall alignment system of claim 1, wherein each elastic convex wall is tapered having a smallest wall thickness on an end away from the first component.

14. The elastic convex wall alignment system of claim 1, wherein the apertures comprise elongated apertures.

15. The elastic convex wall alignment system of claim 14, wherein the elongated apertures comprise rectangular apertures.

16. The elastic tube alignment system of claim 14, wherein each elongated aperture has a beveled aperture wall at an entrance opening of the aperture.

17. The elastic tube alignment system of claim 1, wherein the first component comprises a plurality of first components.

18. A method for precisely aligning components of a motor vehicle during a mating operation, the method comprising:
providing a first vehicle component, the first vehicle component comprising a plurality of upstanding elastic convex walls connected to the first component, the convex walls each having a convex wall surface and a non-convex wall surface;
providing a second vehicle component having a plurality of apertures formed therein, each aperture having an aperture wall, the plurality of apertures of the second component geometrically distributed in a coordinated relationship to a geometrical distribution of the plurality of elastic convex walls such that each elastic convex wall is receivable into a respective aperture;
mating the first vehicle component to the second vehicle component, wherein during mating the first vehicle component is aligned to the second vehicle component by each said elastic convex wall being received into its respective aperture;
elastically deforming an interface between each elastic convex wall and its respective aperture in the second vehicle component; and
performing an elastic averaging of the elastic deformation over the plurality of elastic convex walls such that upon mating, a precise location of the first vehicle component to the second vehicle is realized.

19. The method of claim 18, wherein elastically deforming comprises resiliently reversible elastic deformation of each elastic convex wall.

20. The method of claim 19, wherein during providing, a manufacturing variance of size and position of the elastic convex walls and the apertures occurs, wherein the manufacturing variance has an average length of X, and wherein said step of elastic averaging provides a reduced manufacturing variance of length Xₘᵢₙ, where Xₘᵢₙ=X/√N, wherein N is the number of the elastic convex walls.
